(19) United States
(12) Patent Application Publication
(10) Pub. No.: US 2020/0371589 A1
(43) Pub. Date: Nov. 26, 2020

(54) ACTIVE AND PASSIVE FEEDBACK TO IMPROVE ASSESSMENT

(71) Applicant: Monkeys and Bears, LLC, Herndon, VA (US)

(72) Inventors: Rashmi Rogers, Herndon, VA (US); Jason Rogers, Herndon, VA (US); Abram Sterne, Jerusalem (IL)

(21) Appl. No.: 16/878,086

(22) Filed: May 19, 2020

Related U.S. Application Data
(60) Provisional application No. 62/850,512, filed on May 20, 2019.

(51) Int. Cl. G06F 3/01; G06F 1/16; G06F 9/54

(52) U.S. Cl. CPC G06F 3/015; G06F 9/542; G06F 1/163; G06F 3/017

(57) ABSTRACT

The invention relates to a method for providing active and passive feedback from a user for assessment. The assessment may include current emotional and/or physical state information related to a user and provide personalized reporting to or on behalf of the user. The invention also relates to a system, a wearable device, and components thereof, configured to provide active and passive feedback from a user for assessment.

This application claims priority to U.S. Provisional Patent Application No. 62/850,512 filed May 20, 2019, entitled “ACTIVE AND PASSIVE FEEDBACK TO IMPROVE ASSESSMENT”, the entirety of which is incorporated herein.

### TECHNICAL FIELD

The invention relates to a method for providing active and passive feedback from a user for assessment. The assessment may include, for example, current emotional and/or physical state information related to a user and provide personalized reporting to or on behalf of the user.

### BACKGROUND

Student polling is a well-known method in assessment. In a classroom, a teacher may poll students to check for understanding. Formative assessments may be ongoing assessments, reviews, observations, and feedback to students and teachers in a classroom. “Checking for understanding” is an integral step in the learning and teaching process. Checking for understanding in the framework of assessment may include asking a student relevant questions, gathering feedback from a student, and then planning subsequent teachings based on the gathered feedback. Checking for understanding brings instruction, learning, and assessment together by providing evidence of learning. Additionally, a teacher may use polling to inquire after a student's emotional well-being. This may be asked several times during the day, at different times such as recess or morning work to help gauge the student's emotional well-being.

Student polling may be one way to gather feedback. During a class, a teacher may use polling to determine if her teaching is effective; if all students understood the concepts planned for that day; and based on the results of the polling, determine if she needs to pivot their teachings. Polling may be performed via various different methods such as with a “clicker” or other device distributed to students at the beginning of a class or session. A student may use the clicker to respond to questions posed by a teacher. Questions may be formed in various ways, including multiple choice, sliding scale, and/or binary answer (e.g., yes or no). However, clickers or other such devices may lack the ability to track. That is, clickers or other such devices may not identify the user and hence, there is no way of correlating a student's responses over time. Additionally, a clicker does not record any environmental data corresponding to an answer provided by a student (such as time of day or date). An additional method of performing student polling may include an application or other software executing on a computer or mobile device. A student may interact with the application in order to provide responses. While such an application may be able to identify answers provided by a unique student, the application may still not be able to record any environmental data or biometric feedback from the student corresponding to an answer. Environmental data and biometric feedback, such as heart rate, in addition to variations of such data and feedback, may enable correlation over time that provides valuable insight into any assessment.

### SUMMARY

The various examples disclosed herein relate to a system, a wearable device, and components thereof, configured to provide active and passive feedback from a user for assessment.

A system, for example, may include a wearable device and a server. The wearable device may include a processor, a memory, a transceiver, a biometric sensor, and an environmental sensor. The server may include a transceiver, a processor, and a memory. The system, for example, may also include a data network configured to enable data communication between the wearable device and the server.

The wearable device, for example, may be configured to perform operations to capture an environmental condition via the environmental sensor, capture a biometric condition of a wearer of the wearable device via the biometric sensor, generate a self-identifying condition data set based at least in part on the environmental condition and the biometric condition, and send the self-identifying condition data set to the server via the transceiver of the wearable device.

The server, for example, may be configured to perform operations to receive the self-identifying condition data set from the wearable device via the transceiver of the server, extract the environmental condition and the biometric condition form the self-identifying condition data set, determine whether the wearer of the wearable device is experiencing an abnormal condition based at least in part on the environmental condition and the biometric condition, and, in response to determining that the wearer of the wearable device is experiencing an abnormal condition, notify a party responsible for the wearer of the wearable device.

Additional objects, advantages, and novel features of the examples will be set forth in part in the description which follows, and in part will become apparent to those skilled in the art upon examination of the following and the accompanying drawings or may be learned by production or operation of the examples. The objects and advantages of the present subject matter may be realized and attained by means of the methodologies, instrumentalities, and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a functional block diagram illustrating a system for providing active and passive feedback from a user.

FIG. 2 is an alternate functional block diagram illustrating a system for providing active and passive feedback from a user for assessment.

FIG. 3 is a functional block diagram illustrating elements of a device for capturing active and passive feedback.

FIGS. 4A-4D are simplified diagrams of various user interfaces for use in a device, such as the device illustrated in FIG. 3.

FIG. 5 is a simplified block diagram of a user interface for use in an administrator device, such as used in the systems of FIGS. 1-2.

FIG. 6 is a simplified block diagram of a user interface for use in an administrator device, such as used in the systems of FIGS. 1-2.

FIG. 7 is a flow chart of a simple example of a procedure for capturing active and passive feedback from a user for assessment, which may be implemented in a system like those of FIGS. 1-2.

FIG. 8 is a simplified functional block diagram of a computer that may be configured as a host or server, for example, to function as the remote server or other server in the systems of FIGS. 1-2.

FIG. 9 is a simplified functional block diagram of a personal computer or other user terminal device for use in the systems of FIGS. 1-2.

FIG. 10 is a simplified functional block diagram of a mobile device, as an alternate example of a user terminal device, for possible communication in or with the systems of FIGS. 1-2.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

A wearable device may include many sensors. These sensors may include, for example, heart rate monitors, blood oxygen meters, cameras, and pulse rate monitors. Data collected from a wearable device, either from an individual sensor or collectively from a number of sensors, may reveal a lot of information about the wearer. In various examples, data collected from a sensor in a wearable device may be referred to as ‘passive data’. In various examples, passive data may be used to sense a person's emotions. Using passive data to sense a person's emotions may be referred to as Emotion Sensing Technologies (EST). In one example, the data collected via sensors in a wearable device may be used to create a profile for a person and, based on specific algorithms that may use artificial intelligence, a prediction about the current state of a person's emotions may be determined.

Yet another way to collect data from a person is by prompting or otherwise asking the person. For example, in addition to using EST, the wearable device may also collect ‘active feedback’ from the wearer and record the information. In this example, the active feedback refers to answers and/or other responses provided by a user of the wearable device. The user may provide an answer by responding to a question when prompted to do so; or by simply making a manual entry into the relevant application on the wearable device. Active feedback may provide a way to correlate with the ‘passive data’ and enable deep insights over time. In various examples, the combination of active and passive data may help understand a user's moods, trigger points, and behavior patterns as well as help create a personalized report. Understanding the way a user thinks and feels about things is vital in being able to change the way the user behaves. In this example, the active and passive feedback may help create a more complete picture of a user's emotional well-being. In various examples, active feedback may be provided by a user in different scenarios, such as in conversation with a therapist, or writing a journal, or sharing with a friend or family member.

Another example of combining active and passive feedback to create a more complete assessment of a current state may include a classroom setting. Active feedback may be provided, for example, when a student answers a question. This is the familiar method of ‘checking for understanding’. These questions may be answered verbally, on a piece of paper, or electronically. Active feedback helps teachers evaluate the general level of learning and their own teaching effectiveness. In addition to providing active feedback, passive feedback from the user may also be collected. For example, passive feedback might be able to determine if there is seasonality to a user's learning profile. Other biometric markers such as pulse and blood-oxygen readings may help understand how the user reacts to stress (in reference to the Stress Based Learning Model). The profile created via a combination of active and passive feedback may be very insightful in assessing the user's current state and providing individualized teaching.

Creating a correlation between active and passive data may provide valuable insight into any assessment. This assessment may be used to learn about emotional states, learning patterns, behavior patterns, and/or provide an opportunity to individualize change. An example of such change may be helping a student during the times of the day that are most difficult for the student. In yet another example, such a change may take the form of forming new habits of eating. In another example, the change may be affected by providing individualized therapeutic advice to the individual. With continued use of the technology, continuous active and passive data is collected, hence providing continued insight into the effectiveness of change.

Sensors in wearable devices may collect passive data and provide personalized statics and advice for various applications, such as physical health etc. In one example, a method to take advantage of both methods of feedback may be presented. Such a combination of active and passive feedback may be valuable in other use cases, specifically, in classroom settings, where a combination of such data may provide valuable insights into learning patterns.

The ability to provide personalized advice may be improved by collecting active and passive feedback from a user, such as while answering a question or prompt. The active and passive feedback may be a combination of several parameters corresponding to a timeframe prior to, during, and/or after the user responds to the question or prompt. For example, the active and passive feedback may include the provided answer, a timestamp for when the answer was provided, heart rate and/or other biometric data acquired from the student, environmental conditions (e.g., time of day, ambient temperature, noise level, etc.), and/or other information available during the timeframe. Such feedback may be collected, correlated, and analyzed to provide insights into learning and/or a person's current state as well as help create an individualized plan for change.

In various examples, each active response (e.g., an answer to a question) may be accompanied by one or more additional data points. The one or more data points may include a timestamp, a unique identifier (ID) of a respondent, a subject being taught, a location (e.g., a GPS coordinated location), an identification of the location type (e.g., indoor or outdoor), a heart rate of the respondent, a sweat reading (from a sweat sensor), a temperature of the respondent, an ambient temperature of the location, an ambient air pressure of the location, a blood pressure of the respondent, a blood sugar level of the respondent, and/or other information. In other examples, an active response may be collected without any additional information.

An active response and any additional data points may be collected into a response packet by a wearable device, such as a watch or other smart device, worn by or in close proximity to a student or other respondent. Each response packet may be a self-identifying data set based at least in part on an environmental condition and a biometric condition represented by any additional data points. A data set is self-identifying, for example, because the individual data set may be identified based on information contained within the data set. The identification may be based, for example, on any one or some combination of elements within the data set. For example, the identification may be based on a timestamp of the response packet, a device identifier (ID) that uniquely identifies a device, and/or a user ID that uniquely identifies an individual. In a further example, identification of a data set may also be based on environmental conditions and/or biometric conditions contained within the data set.

A controller may collect the response packet from the student, as well as response packets from other students. In one example, the controller may be a raspberry pi computer. In another example, the controller may be a server or other computer system. In various examples, the controller may be located on a local area network (LAN) or wide area network (WAN) in relatively close proximity to a student. Alternatively, or in addition, the controller may be located in a remote location, such as on the Internet. The controller and wearable devices may communicate via various wired and wireless communication protocols, such as Bluetooth, Bluetooth low energy (BLE), Wi-Fi, serial (UART), Zigbee, sub-megahertz communication protocols, ethernet, visible light communication (VLC), long term evolution (LTE), etc.

When a controller receives a response packet, the controller may extract a self-identifying data set from the response packet and register, record, and/or otherwise store an identification of the self-identifying data set. Further, the controller may extract the active response and any additional data points from the self-identifying data set. The controller may then analyze the various information, either alone (i.e., a single response and any additional data points) and/or in combination with information extracted from other response packets. For example, the controller may analyze a response packet received from a single student corresponding to a single question or series of questions. In this example, the controller may similarly analyze each response packet received from each student. In another example, the controller may analyze response packets collected from a number of students corresponding to a single question or series of questions. In still another example, the controller may analyze a series of response packets received from a single student corresponding to a single question or series of questions (e.g., a pre-assessment and a post-assessment). In various examples, the single question or series of questions may be related to primary emotions, secondary emotions, and/or strength of emotions. In this way, assessments may be performed for individual students as well as groups of students and such assessments may correspond to a point in time as well as over a period of time.

Analysis performed by the controller may be presented in various readable formats. For example, analysis results may include a pie chart, bar graph, mosaic chart, line graph, and/or some other graphical format. Alternatively, or in addition, analysis results may include a document, worksheet, and/or some other textual format. The analysis may be provided, for example, to a user, to a teacher and/or other student supervisor, and/or to a parent and/or other responsible party. Analysis results may be stored, for example, over a period of time for future reference and may be compared, for example, with other analysis results, such as a single student or group of students over a period of time or other groups of students (e.g., same grade/different classroom, same grade/different school, same district, different district, same state, different state, nationwide, etc.). In another example, an analysis of emotional wellness of a demographic, such as women in the age group of 40-50, may provide insightful trends. Over time, a valuable picture of a user's performance, weaknesses, strengths, areas of improvement, and other parameters of interest to the user, a teacher, administrator, parent, and/or other interested party may be developed.

While the various examples discussed herein may specifically mention assessment, this is only for simplicity. The invention described herein may be utilized in a number of additional applications where a user's response in conjunction with additional biometric and environmental feedback may be useful. For example, such applications may include summative assessment, polling for market-product fit type assessment, correlation of stress based model of learning with metacognitive methods of teaching, and/or other such assessments (e.g., enterprise learning or education in the workplace, to include processes, project management, environmental and health safety).

The invention described herein may also enable an individual (i.e., a student or other respondent) to learn and/or improve techniques in time management and test management. Additional use cases include monitoring social-emotional well-being. The administrator, such as a teacher, may pose one or more questions via an app on a wearable worn by the user to inquire after the users' emotional wellbeing. Examples of such a question might be, ‘How are you feeling?’, ‘How is your day going?’. Based on responses to these questions, the administrator can identify any user that might need immediate attention.

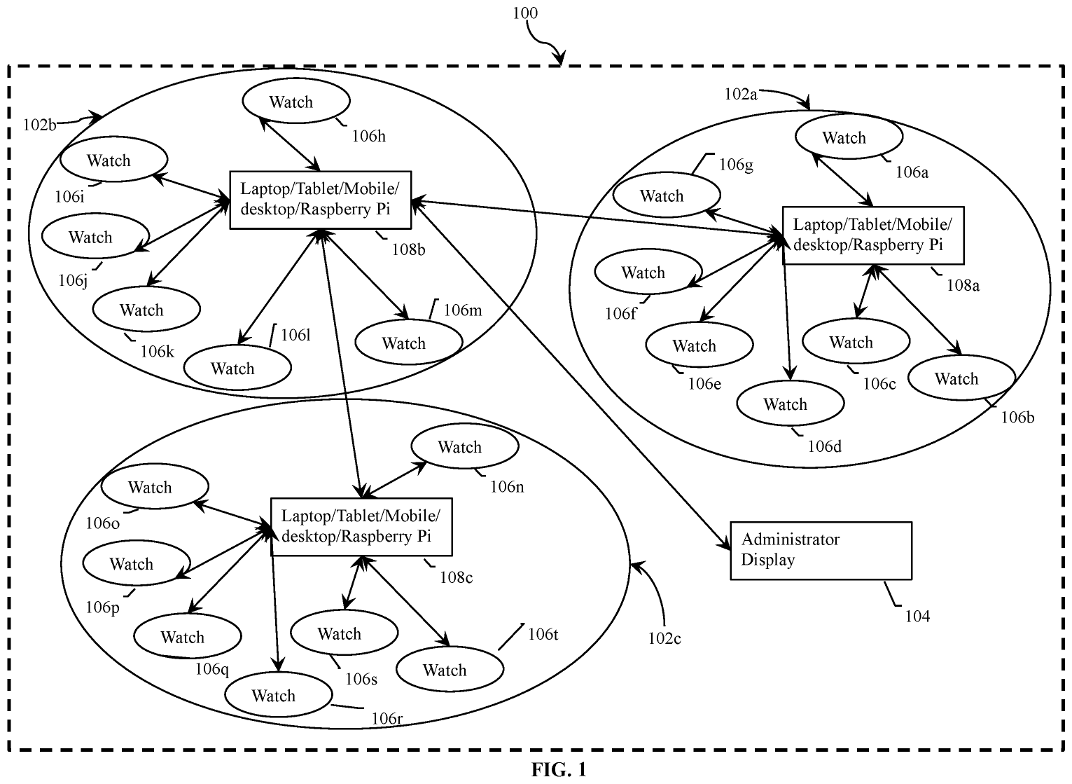

FIG. 1 illustrates a system 100 for use in providing active and passive feedback from a user for assessment. The system 100 may include an administrator display 104 and one or more clusters 102a, 102b, 102c. The administrator display 104 may be, for example, a teacher's computer, laptop, tablet, mobile device, smart board, or other display. Each cluster 102a, 102b, 102c may include a controller 108a, 108b, 108c. Each controller 108a, 108b, 108c may be, for example, a raspberry pi computer, desktop, laptop, tablet, mobile device, or some other computing device. Each cluster 102a, 102b, 102c may include one or more wearable devices for capturing active and passive feedback from a user. For example, cluster 102a may include watches 106a . . . g, cluster 102b may include watches 106h . . . m, and cluster 102c may include watches 106n . . . t. Although system 100 of FIG. 1 shows three clusters, this is only for simplicity and system 100 may include more or fewer clusters. In various examples, system 100 may correspond to a single class, such as a classroom within a school. In other examples, system 100 may correspond to multiple classes. For example, cluster 102a may correspond to one class, cluster 102b may correspond to one class, and cluster 102c may correspond to one class.

In one example, controllers 108a, 108b, 108c may be interconnected via communication links. In this example, controllers 108a, 108b, 108c may also be interconnected with administrator display 104 via communication links. Communications links may be, for example, Bluetooth, BLE, LTE, Wi-Fi, VLC, ethernet, Zigbee, and/or some other communications link. Further in this example, watches within a cluster may also be interconnected with a corresponding controller. For example, within cluster 102b, watches 106h . . . m may be interconnected with controller 108b via one or more communication links.

In various examples, a watch, such as watch 106a, may capture a response from a user as well as any additional data points, such as an environmental condition and/or a biometric condition. The watch may create a response packet that includes the user response and any additional data points. Each response packet may be a self-identifying data set based at least in part on an environmental condition and a biometric condition represented by any additional data points. The identification may be based, for example, on any one or some combination of elements within the data set. For example, the identification may be based on a timestamp of the response packet, a device identifier (ID) that uniquely identifies a device, and/or a user ID that uniquely identifies an individual. In a further example, identification of a data set may also be based on environmental conditions and/or biometric conditions contained within the data set. The watch may then send the response packet to a controller, such as controller 108a.

In turn, the controller may receive the response packet, as well as response packets from other watches, extract a self-identifying data set from the response packet and register, record, and/or otherwise store an identification of the self-identifying data set. Further, the controller may extract the user response and any additional data points from the self-identifying data set, stored the extracted information, and analyze the extracted information. The analysis may then be presented via a display, such as administrator display 104. In this way, active and passive feedback may be provided from a user for assessment.

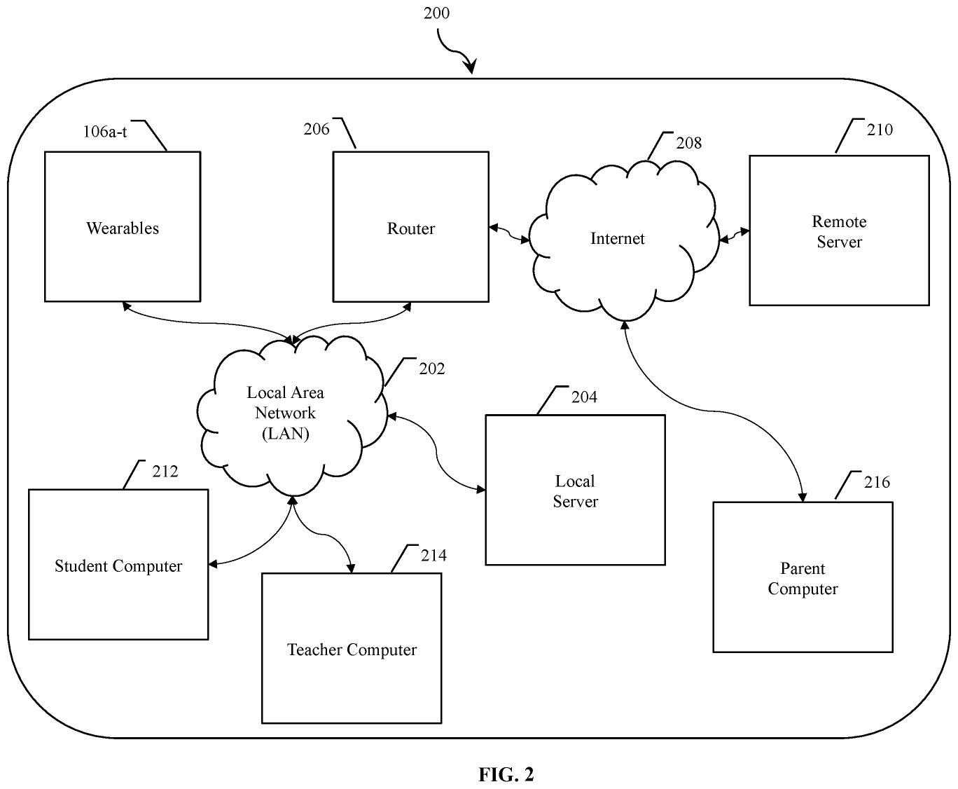

FIG. 2 illustrates a system 200 for use in providing active and passive feedback from a user for assessment. System 200 may include, for example, a number of wearable devices, such as watches 106a . . . t as shown in system 100 of FIG. 1. In one example, the wearable devices may be interconnected via a local area network (LAN) 202 with student computer 212, teacher computer 214, local server 204, and router 206. Further in this example, the wearable devices may be interconnected via LAN 202 and/or router 206 with remote server 210 and parent computer 216 via the Internet 208. Although FIG. 2 shows student computer 212, teacher computer 214, local server 204, remote server 210, and parent computer 216 each as single elements, this is only for simplicity and each may include a number of elements. For example, student computer 212 may include multiple computers, one for each student or each group of students.

In various examples, local server 204 and remote server 210 may be used to collect and store responses and any additional information collected from students via the wearables. Such collection and storage may be in addition to or in place of similar functionality performed by controllers 108a, 108b, 108c in system 100 of FIG. 1. In addition, local server 204 and/or remoter server 210 may perform, for example, analysis on the collected responses and additional information. Such analysis, in turn, may be provided, for example, to a teacher via teacher computer 214 and/or a parent or other responsible party via parent computer 216.

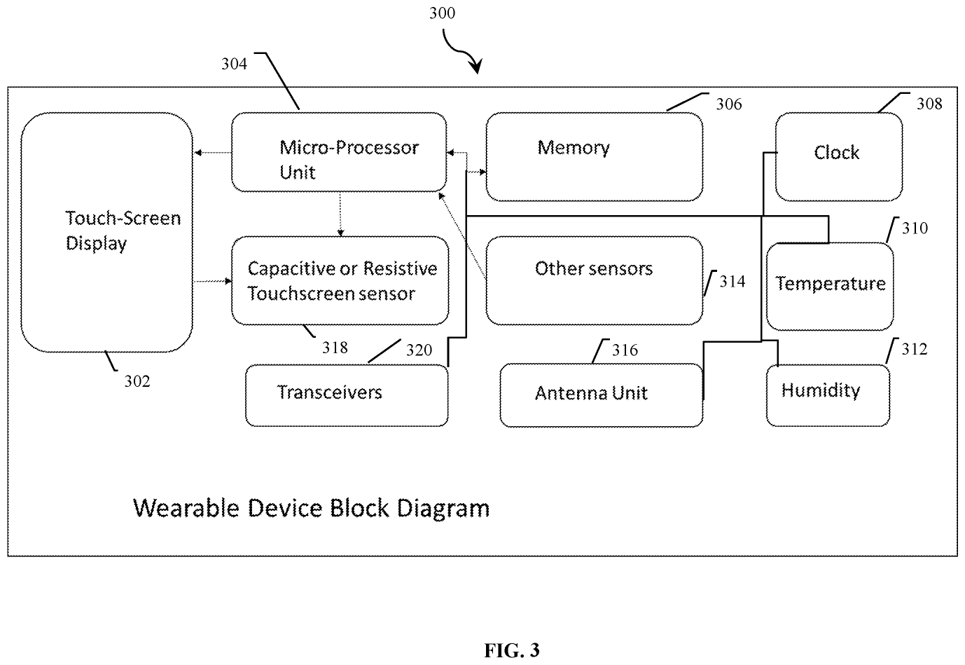

FIG. 3 illustrates a simple block diagram of a wearable device 300 for use in providing active and passive feedback from a user. Wearable device 300 may be, for example, any one of watches 106a . . . t of the system 100 of FIG. 1. In various examples, wearable device 300 may include a micro-processor unit 304 connected to a memory 306. Memory 306 may include, for example, random access memory (RAM), read-only memory (ROM), flash memory, and/or some other form of memory.

Wearable device 300 may also include a touch-screen display 302 and a capacitive or resistive touch-screen sensor 318. Touch-screen display 302 may be used, for example, to provide prompts to and receive responses from a user. In one example, wearable device 300 may include an antenna unit 316 and one or more transceivers 320. Transceivers 320 may include, for example, a Wi-Fi transceiver, an LTE transceiver, a Bluetooth transceiver, a BLE transceiver, a Zigbee transceiver, and/or some other transceiver for short-range communications.

In one example, wearable device 300 may include a clock 308, a temperature sensor 310, a humidity sensor 312, and/or one or more other sensors 314. The one or more other sensors 314 may include, for example, a heart rate sensor, a global positioning service (GPS) sensor, a blood pressure sensor, and/or some other biometric and/or ambient condition sensor.

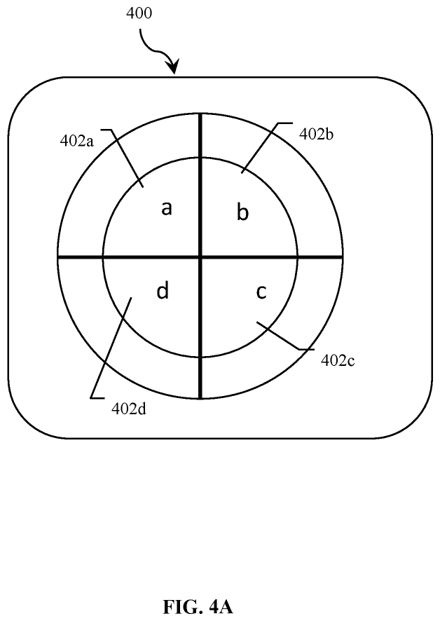

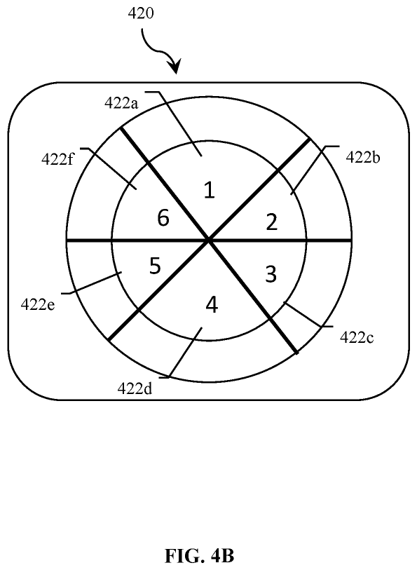

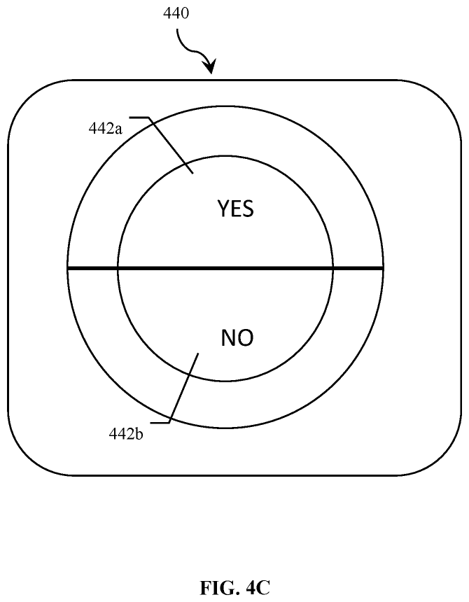

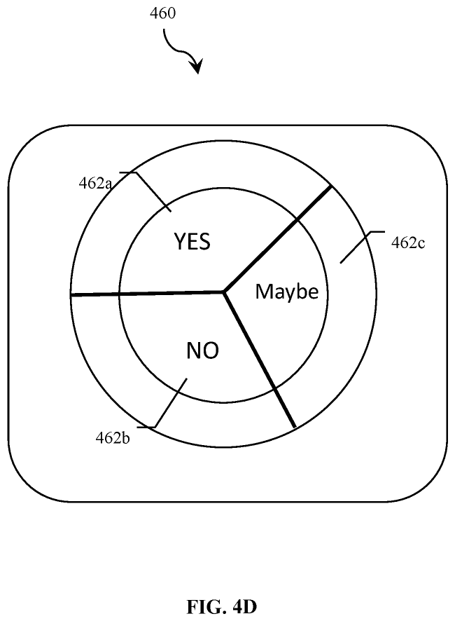

FIG. 4A illustrates a simple user interface 400 that may be presented, for example, to a user of a wearable device, such as wearable device 300 of FIG. 3. In one example, user interface 400 may be presented via a touch-screen display, such as touch-screen display 302. User interface 400 may present, for example, prompts 402a, 402b, 402c, 402d. Prompts 402a, 402b, 402c, 402d may represent, for example, alternative answers to a multiple choice question. In response to a multiple choice question asked by a teacher, a student may select one of prompts 402a, 402b, 402c, 402d.

FIG. 4B illustrates another simple user interface 420 that may be presented, for example, to a user of a wearable device, such as wearable device 300 of FIG. 3. In one example, user interface 420 may be presented via a touch-screen display, such as touch-screen display 302. User interface 420 may present, for example, prompts 422a . . . f Prompts 422a . . . f may represent, for example, alternative answers to a multiple choice question. In response to a multiple choice question asked by a teacher, a student may select one of prompts 422a . . . f.

FIG. 4C illustrates an alternative simple user interface 440 that may be presented, for example, to a user of a wearable device, such as wearable device 300 of FIG. 3. In one example, user interface 440 may be presented via a touch-screen display, such as touch-screen display 302. User interface 440 may present, for example, prompts 442a, 442b. Prompts 442a, 442b may represent, for example, alternative answers to a yes/no or true/false question. In response to a yes/no or true/false question asked by a teacher, a student may select one of prompts 442a, 442b.

FIG. 4D illustrates still another simple user interface 460 that may be presented, for example, to a user of a wearable device, such as wearable device 300 of FIG. 3. In one example, user interface 460 may be presented via a touch-screen display, such as touch-screen display 302. User interface 460 may present, for example, prompts 462a, 462b, 462c. Prompts 462a, 462b, 462c may represent, for example, alternative answers to a yes/no/maybe question. In response to a yes/no/maybe question asked by a teacher, a student may select one of prompts 462a, 462b, 462c.

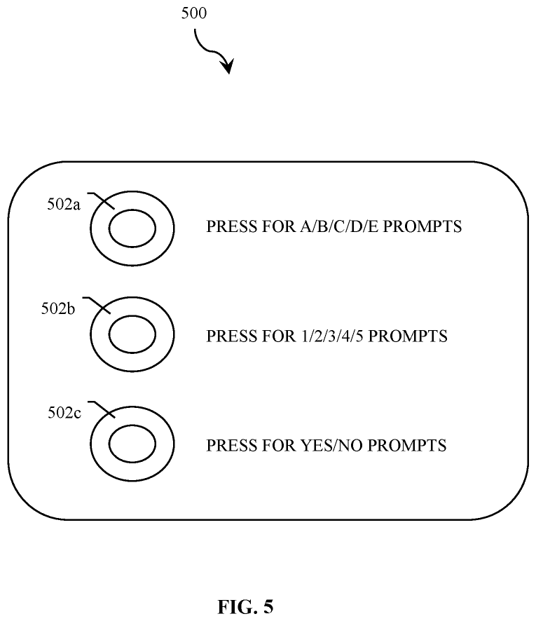

FIG. 5 illustrates a simple user interface 500 that may be presented, for example, on an administrator display, such as administrator display 104 of FIG. 1 or teacher computer 214 of FIG. 2. User interface 500 may include, for example, options 502a, 502b, 502c. In one example, options 502a, 502b, 502c correspond to a type of question to be asked by a teacher and the type of prompts to be presented on a wearable device. For example, option 502a may correspond to a multiple choice question having lettered choices (e.g., A/B/C/D/E). In this example, a teacher may ask a multiple choice question and select option 502a which, in turn, would trigger a user interface, such as user interface 400 of FIG. 4A, to be presented on a wearable device.

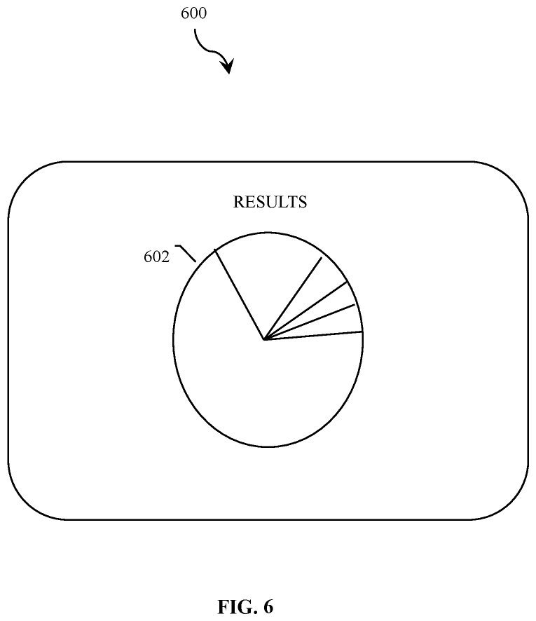

FIG. 6 illustrates a simple user interface 600 that may be presented, for example, via teacher computer 214, parent computer 216, and/or student computer 212 of FIG. 2. User interface 600 may include, for example, results 602. In one example, results 602 may include an analysis of responses provided from wearable devices. That is, results 602 may present a summation or aggregation of answers to a question (e.g., 5 students selected A, 2 students selected B, etc.). In another example, results 602 may include an analysis of responses and any other information collected from wearable devices. In this example, results 602 may present a summation or aggregation of answers to a question as well as information describing or otherwise representing conditions of respondents and/or an environment. Although user interface 600 shows a single results 602 (i.e., a pie chart), this is only for simplicity and multiple results and/or a single result with multiple components or elements may be presented. Results may include, for example, a pie chart, a bar graph, a mosaic chart, a line graph, a document, a worksheet, some other graphical or textual format, and/or some combination of formats.

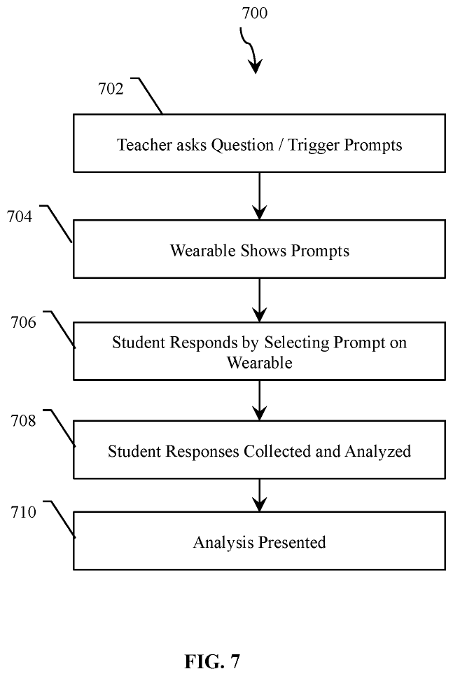

FIG. 7 illustrates a flow chart of an example of a method 700 for providing active and passive feedback from a user for assessment. Method 700 may be used, for example, within a system, such as system 100 of FIG. 1 and/or system 200 of FIG. 2.

In step 702, a teacher, for example, may ask a question and trigger prompts to be displayed on a wearable device, such as watches 106a . . . t. In one example, a user may be prompted “How are you feeling right now?” and provided with a list of choices such as “Happy”, “Sad”, “Anxious”, “Calm”, “Stessed”. In another example, a teacher may ask “Does 2+2 equal 5?” and, via interaction with an administrative display such as teacher computer 214, the teacher may trigger a yes/no prompt to be presented.

In step 704, a wearable device may show the triggered prompts. For example, a wearable device, such as one of watches 106a . . . t, may present a yes/no prompt as triggered in order to respond to the question “Does 2+2 equal 5?” In another example, a wearable device may present a slider to represent a scale of 1-100 and expect a user to indicate a number of the scale that best relates to how a current emotion is affecting the user.

In step 706, a student, for example, may respond by selecting one of the displayed prompts. Student responses, for example, may be collected and analyzed in step 708. Such collection and analysis may be performed, for example, by local server 204 and/or remote server 210.

In turn, results and/or analysis, for example, may be presented in step 710. Such presentation of analysis may be performed, for example, by teacher computer 214, parent computer 216, and/or student computer 212. In this way, active and passive feedback may be provided from a user for assessment.

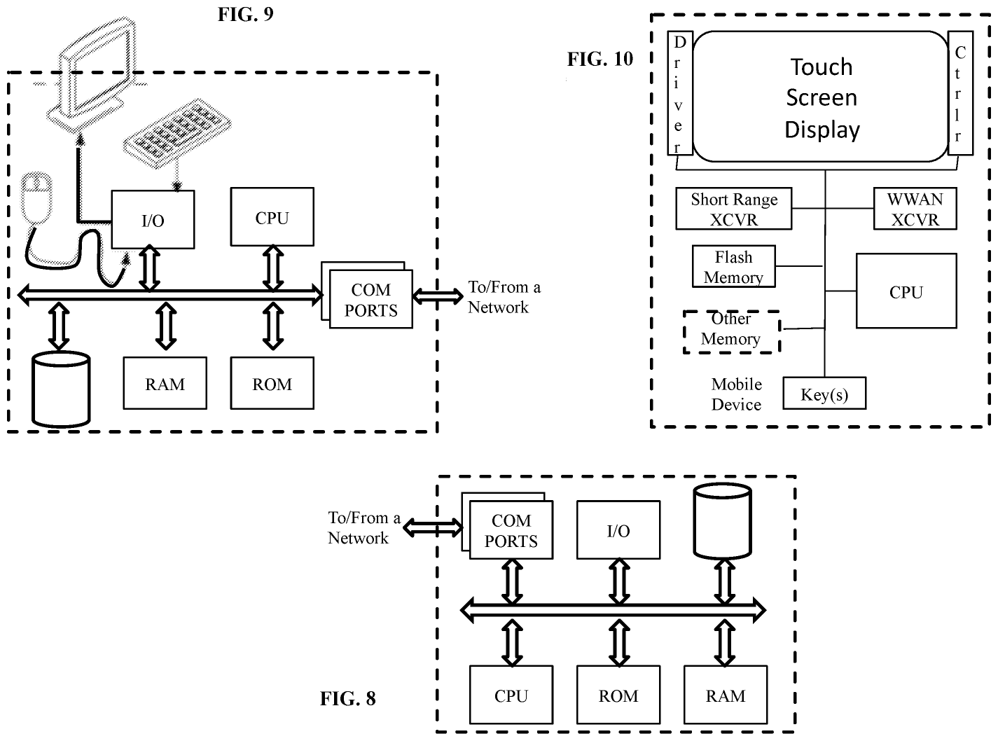

As shown by the above discussion, although many intelligent processing functions of the system 100 may be implemented in a wearable device such as device 300, at least some functions of devices associated with or in communication with the system 100 as discussed relative to FIGS. 1-7 may be implemented with general purpose computers or other general purpose user terminal devices, although special purpose devices may be used. FIGS. 8-10 provide functional block diagram illustrations of examples of general purpose hardware platforms.

FIG. 8 illustrates a network or host computer platform, as may typically be used to implement a host or server, such as the remote server 210 in FIG. 2. FIG. 9 depicts a computer with user interface elements, as may be used to implement a personal computer or other type of work station or terminal device, such as one of the student computer 212, teacher computer 214, or parent computer 216 in FIG. 2, although the computer of FIG. 9 may also act as a server if appropriately programmed. The block diagram of a hardware platform of FIG. 10 represents an example of a mobile device, such as a tablet computer, smartphone, or the like with a network interface to a wireless link, which may alternatively serve as a user terminal device like student computer 212, teacher computer 214, or parent computer 216. It is believed that those skilled in the art are familiar with the structure, programming, and general operation of such computer equipment and as a result the drawings should be self-explanatory.

A server (see e.g. FIG. 8), for example, may include a data communication interface for packet data communication via the particular type of available network. The server may also include a central processing unit (CPU), in the form of one or more processors, for executing program instructions. The server platform typically includes an internal communication bus, program storage, and data storage for various data files to be processed and/or communicated by the server, although the server often receives programming and data via network communications. The hardware elements, operating systems, and programming languages of such servers are conventional in nature, and it is presumed that those skilled in the art are adequately familiar therewith. Of course, the server functions may be implemented in a distributed fashion, such as via cloud computing, on a number of similar platforms, to distribute the processing load.

A computer type user terminal device, such as a desktop or laptop type personal computer (PC), similarly may include a data communication interface, CPU, main memory (such as a random access memory (RAM)) and one or more disc drives or other mass storage devices for storing user data and the various executable programs (see e.g. FIG. 9). A mobile device (see e.g. FIG. 10) type user terminal may include similar elements, but will typically use smaller components that also require less power, to facilitate implementation in a portable form factor. The example of FIG. 10 includes a wireless wide area network (WWAN) transceiver (XCVR) such as a 3G, 4G, or 5G cellular network tranceiver as well as a short range wireless transceiver such as a Bluetooth and/or WiFi transceiver for wireless local area network (WLAN) communication. The computer hardware of FIG. 8 and the terminal computer platform of FIG. 9 are shown by way of example as using a RAM type main memory and a hard disk drive for mass storage of data and programming, whereas the mobile device of FIG. 10 includes a flash memory and may include other miniature memory devices. It may be noted, however, that more modern computer architectures, particularly for portable usage, are equipped with semiconductor memory only.

The various types of user terminal devices may also include various user input and output elements. A computer, for example, may include a keyboard and a cursor control/selection device such as a mouse, trackball, joystick, or touchpad; and a display for visual outputs (see FIG. 9). The mobile device example in FIG. 10 uses a touchscreen type display, where the display is controlled by a display driver, and user touching of the screen is detected by a touch sense controller (Controller). The hardware elements, operating systems, and programming languages of such computer and/or mobile user terminal devices also are conventional in nature, and it is presumed that those skilled in the art are adequately familiar therewith.

Although FIGS. 8-10 in their present form show computers and user terminal devices, generally similar configurations also may be used within other elements of the systems 100, 200.

As also outlined above, aspects of the techniques for providing active and passive feedback for assessment may involve some programming, e.g. programming of the appropriate wearables 206, remote server 210, student computer 212, teacher computer 214, parent computer 216, and/or computers, terminals, or the like in communication therewith. Program aspects of the technology discussed above therefore may be thought of as “products” or “articles of manufacture” typically in the form of executable code and/or associated data (software or firmware) that is carried on or embedded in a type of machine readable medium. “Storage” type media include any or all of the tangible memory of the computers, processors, or the like, or associated modules thereof, such as various semiconductor memories, tape drives, disk drives, and the like, which may provide non-transitory storage at any time for the software or firmware programming. All or portions of the programming may at times be communicated through the Internet or various other telecommunication networks. Such communications, for example, may enable loading of the software from one computer or processor into another. Thus, another type of media that may bear the software/firmware program elements includes optical, electrical, and electromagnetic waves, such as used across physical interfaces between local devices, through wired and optical landline networks and other various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “a” or “an” does not, without further constraints, preclude the existence of additional identical elements in the process, method, article, or apparatus that comprises the element.

Unless otherwise stated, any and all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

What is claimed is:

1. A system, comprising:
a wearable device comprising:
an environmental sensor;
a biometric sensor;
a transceiver;
a memory; and
a processor coupled to the transceiver and the memory; and
a server comprising:
a transceiver;
a memory; and
a processor, wherein:
processor-executable instructions stored in the memory of the wearable device configures the processor of the wearable device to perform operations to:
capture an environmental condition via the environmental sensor;
capture a biometric condition of a wearer of the wearable device via the biometric sensor;
generate a self-identifying condition data set based at least in part on the environmental condition and the biometric condition; and
send the self-identifying condition data set to the server via the transceiver of the wearable device; and
processor-executable instructions stored in the memory of the server configures the processor of the server to perform operations to:
receive the self-identifying condition data set from the wearable device via the transceiver of the server;
extract the environmental condition and the biometric condition from the self-identifying condition data set;
determine whether the wearer of the wearable device is experiencing an abnormal condition based at least in part on the environmental condition and the biometric condition; and
in response to determining that the wearer of the wearable device is experiencing an abnormal condition, notify a party responsible for the wearer of the wearable device.

2. The system of claim 1, wherein:
the wearable device further comprises a display coupled to the processor and the memory;
processor-executable instructions stored in the memory of the wearable device further configures the processor of the wearable device to perform operations to:
display a prompt to the wearer of the wearable device via the display;
receive, via the display, a response to the prompt from the wearer of the wearable device; and
modify the self-identifying condition data set to include the received response; and
processor-executable instructions stored in the memory of the server further configures the processor of the wearable device to perform operations to:
extract the received response from the self-identifying condition data set;
determine a validity of the received response based at least in part on the environmental condition and the biometric condition; and
notify a party responsible for the wearer of the wearable device of the received response and the validity of the received response.

3. A wearable device, comprising:
an environmental sensor;
a biometric sensor;
a transceiver;
a memory; and
a processor coupled to the transceiver and the memory,
wherein processor-executable instructions stored in the memory configures the processor to perform operations to:
capture an environmental condition via the environmental sensor;
capture a biometric condition of a wearer of the wearable device via the biometric sensor;
generate a self-identifying condition data set based at least in part on the environmental condition and the biometric condition; and
send the self-identifying condition data set to a server via the transceiver.

4. The wearable device of claim 3, wherein processor-executable instructions stored in the memory configure the processor to perform operations to:
determine whether the wearer of the wearable device is experiencing an abnormal condition based at least in part on the environmental condition and the biometric condition; and
in response to determining that the wearer of the wearable device is experiencing an abnormal condition, notify a party responsible for the wearer of the wearable device.

5. The wearable device of claim 3, wherein processor-executable instructions stored in the memory configures the processor to perform operations to generate the self-identifying condition data set by performing operations to:
concatenate the environmental condition and the biometric condition;
generate a hash of the concatenated environmental and biometric conditions;
encrypt the hash using a public key corresponding to the server;
append the encrypted hash to the concatenated environmental and biometric conditions; and
encrypt the concatenated environmental and biometric conditions and appended encrypted hash using a private key corresponding to the wearable device.

6. The wearable device of claim 3, further comprising a display coupled to the processor and the memory, wherein processor-executable instructions stored in the memory further configures the processor to perform operations to:
display a prompt to the wearer of the wearable device;
receive, via the display, a response to the prompt from the wearer of the wearable device; and
modify the self-identifying condition data set to include the received response.

7. The wearable device of claim 6, wherein processor-executable instructions stored in the memory further configures the processor to perform operations to:
determine a validity of the received response based at least in part on the environmental condition and the biometric condition; and
notify a party responsible for the wearer of the wearable device of the received response and the validity of the received response.

8. A method, comprising:
capturing, by a wearable device processor and via an environmental sensor of the wearable device, an environmental condition;
capturing, by the wearable device processor and via a biometric sensor of the wearable device, a biometric condition of a wearer of the wearable device;
generating a self-identifying condition data set based at least in part on the environmental condition and the biometric condition; and
sending the self-identifying condition data set to a server via the transceiver.

9. The method of claim 8, further comprising:
determining whether the wearer of the wearable device is experiencing an abnormal condition based at least in part on the environmental condition and the biometric condition; and
in response to determining that the wearer of the wearable device is experiencing an abnormal condition, notifying a party responsible for the wearer of the wearable device.

10. The method of claim 8, further comprising:
displaying, via a display of the wearable device, a prompt to the wearer of the wearable device;
receiving, via the display, a response to the prompt from the wearer of the wearable device; and
modifying the self-identifying condition data set to include the received response.

11. The method of claim 9, further comprising:
determining a validity of the received response based at least in part on the environmental condition and the biometric condition; and
notifying a party responsible for the wearer of the wearable device of the received response and the validity of the received response.
